(19) United States
(12) Patent Application Publication
(10) Pub. No.: US 2014/0152164 A1
(43) Pub. Date: Jun. 5, 2014

(54) EXTENSION TRAY FOR DATA STORAGE DEVICE

(71) Applicant: HON HAI PRECISION INDUSTRY CO., LTD., New Taipei (TW)

(72) Inventor: SHUN-SIANG TU, New Taipei (TW)

(73) Assignee: HON HAI PRECISION INDUSTRY CO., LTD., New Taipei (TW)

(21) Appl. No.: 13/962,910

(22) Filed: Aug. 8, 2013

(30) Foreign Application Priority Data
Dec. 4, 2012 (TW) 101145527

(51) Int. Cl. G06F 1/18

(52) U.S. Cl. CPC G06F 1/187
USPC 312/333

(57) ABSTRACT

An extension tray for a data storage device includes a bottom wall, two sidewalls, and a detaching assembly. The two sidewalls are substantially perpendicular to the bottom wall. The two sidewalls are substantially parallel to each other. A buffer member protrudes form one of the two sidewalls to buffer a movement of the data storage device when the data storage device moves between the two sidewalls. A detaching assembly is accessible through one of the two sidewalls. The detaching assembly moves along a first direction to urge the data storage device to move along a second direction. The first direction is substantially perpendicular to the second direction.

### BACKGROUND

1. Technical Field

The disclosure generally relates to extension trays for data storage devices, especially to an extension tray for receiving a data storage device.

2. Description of Related Art

A data storage device, such as a hard disk drive, is directly screwed to a computer chassis. This mounting means can be complex, difficult, and time-consuming during installation. In addition, vibration from other nearby components can be directly transferred to the data storage device through the screws. The data storage device may suffer damage over time from the vibrations. As a result, efforts have been taken to introduce a mounting apparatus for reducing vibration of data storage devices.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an extension tray and a data storage device in one embodiment.

FIG. 2 is an enlarged view of a circled portion II of FIG. 1.

FIG. 3 is an enlarged view of a circled portion III of FIG. 1.

FIG. 4 is an assembled view of the extension tray and the data storage device of FIG. 1.

FIG. 5 is plan view of the extension tray and the data storage device of FIG. 4.

FIG. 6 is similar to FIG. 5, but the data storage device is slightly moved.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

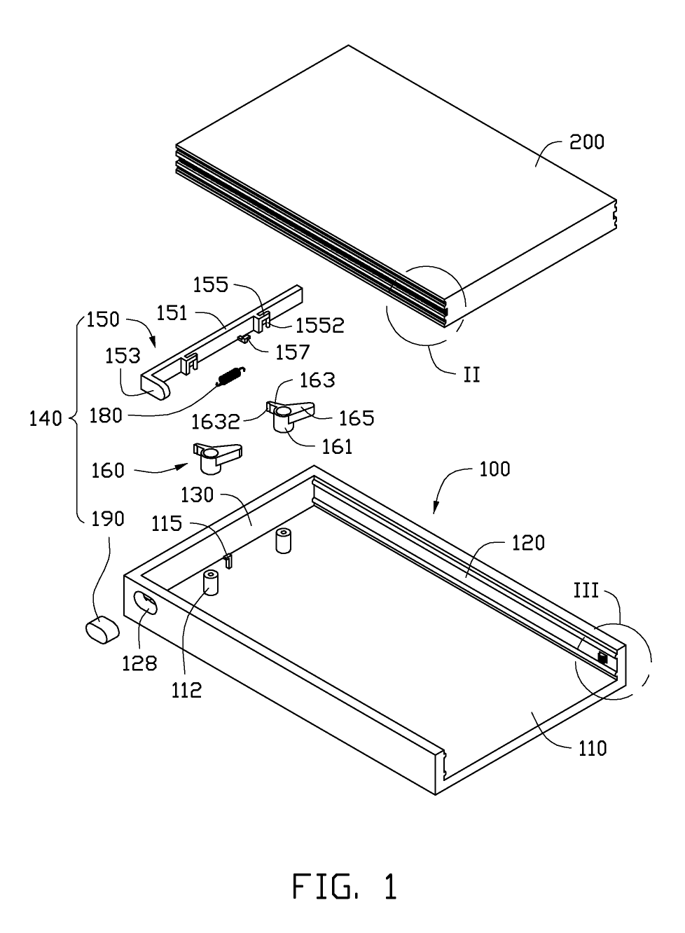

FIG. 1 illustrates an exploded view of an extension tray 100 and a data storage device 200. The extension tray 100 can receive the data storage device 200.

The extension tray 100 includes a bottom wall 110, two sidewalls 120, a rear wall 130, and a detaching assembly 140.

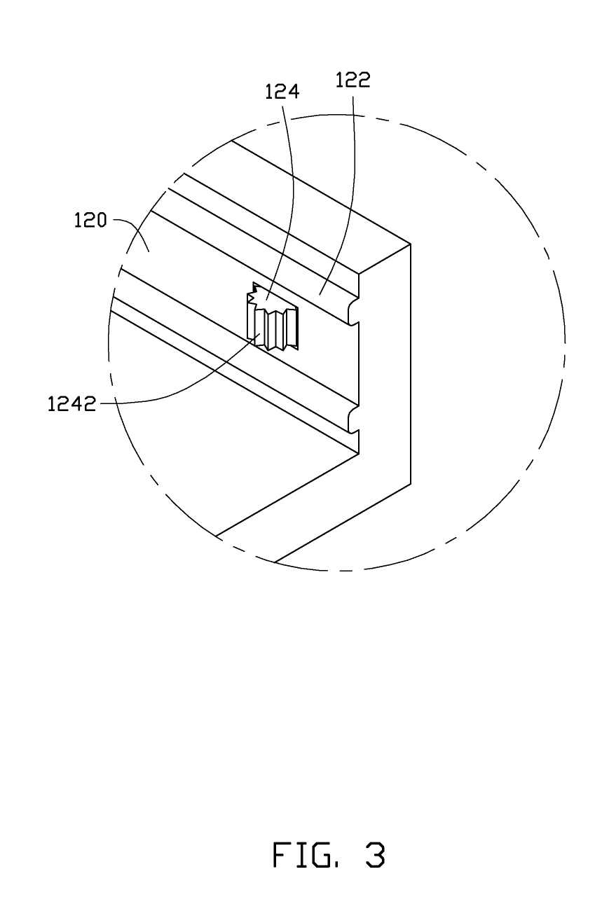

FIG. 3 illustrates a partial enlarged portion of the extension tray 100. The two sidewalls 120 are substantially perpendicular to the bottom wall 110. The two sidewalls 120 are substantially parallel to each other. The rear wall 130 is substantially perpendicular to the two sidewalls 120 and the bottom wall 110. Two pivot pins 112 and a first hook 115 are located on the bottom wall 110. Two guiding rails 122 are respectively located on an inner side of each of the two sidewalls 120. A buffer member 124 is located between the two guiding rails 122. The buffer member 124 can be rotated relative to the sidewall 120. The buffer member 124 can be a wheel. The wheel includes a plurality of teeth 1242. A through hole 128 is defined in one of the two sidewalls 120.

The detaching assembly 140 includes a button 190, a rod 150, a resilient element 180, and two pushing rotators 160. The rod 150 includes a body 151, a bent portion 153, a second hook 157, two connecting portions 155, and two engaging posts 1552. The bent portion 153 is substantially perpendicular to the body 151. Each of the two pushing rotators 160 includes a shield 161, a driving portion 163, and a pushing portion 165. A recess 1632 is defined in the driving portion 163 to receive the engaging post 1552. An angle defined between the driving portion 163 and the pushing portion 165 is substantially greater than 90 degrees.

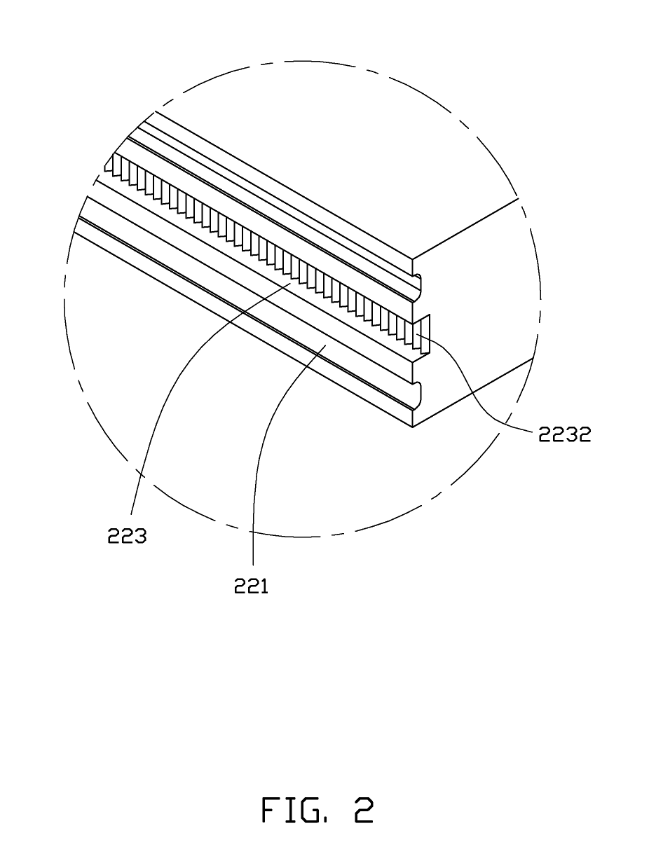

FIG. 2 illustrates a partial enlarged portion of the data storage device 200 of FIG. 1. The data storage device 200 may be a hard disk drive or a CD-ROM drive. Two guiding slots 221 are respectively defined in each side of the data storage device 200. A groove 223 is defined between the two guiding slots 221. A plurality of second teeth 2232 is located in the groove 223.

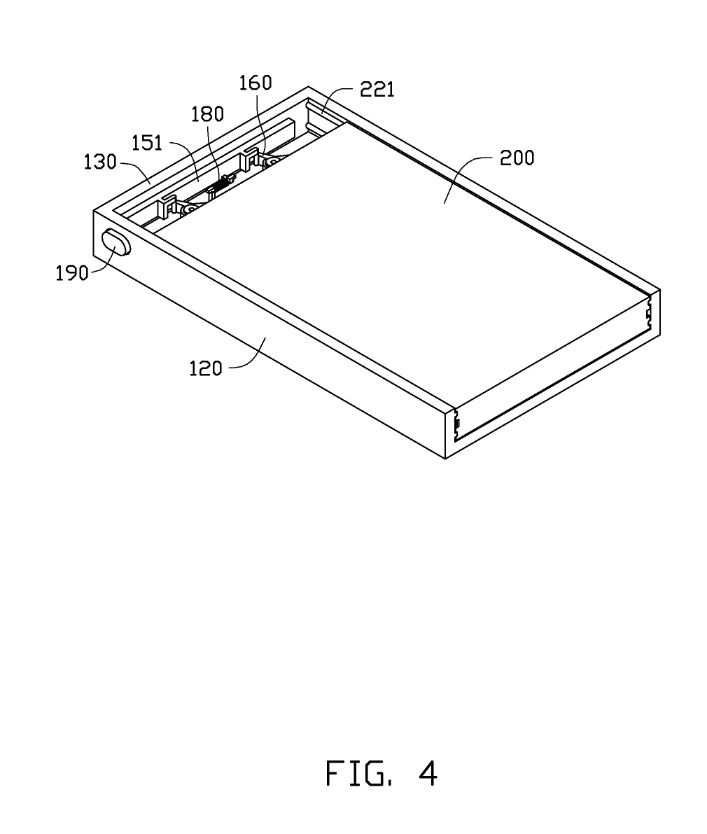

FIG. 4 illustrates an assembled view of the extension tray 100 and the data storage device 200. In assembly, the rod 150 is located on the bottom wall 110 adjacent to the rear wall 130. The button 190 is located in the through hole 128. The two pushing rotators 160 are located on the two pivot pins 112. The resilient element 180 is secured to the first hook 115 and the second hook 157. The button 190 abuts the bent portion 153.

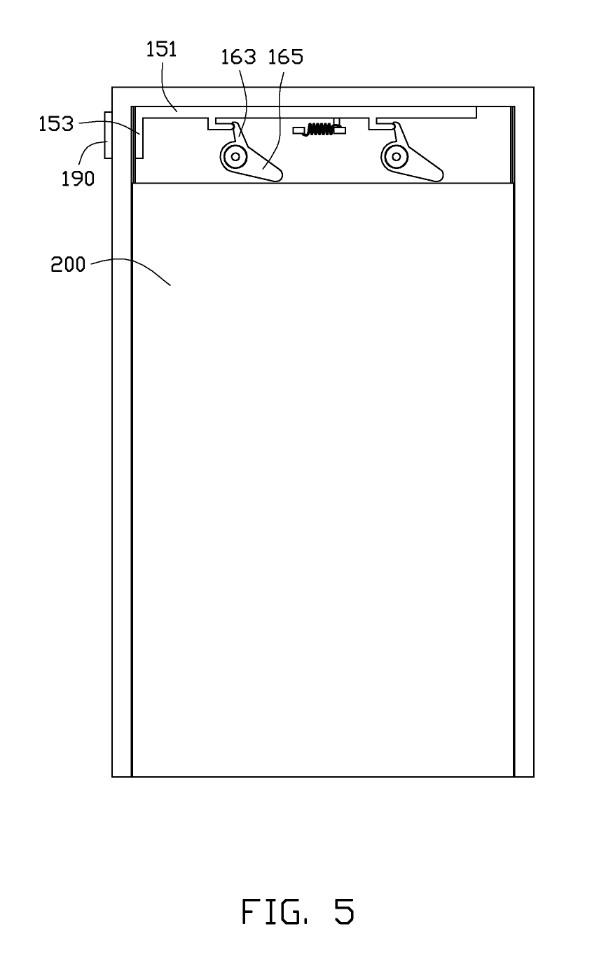

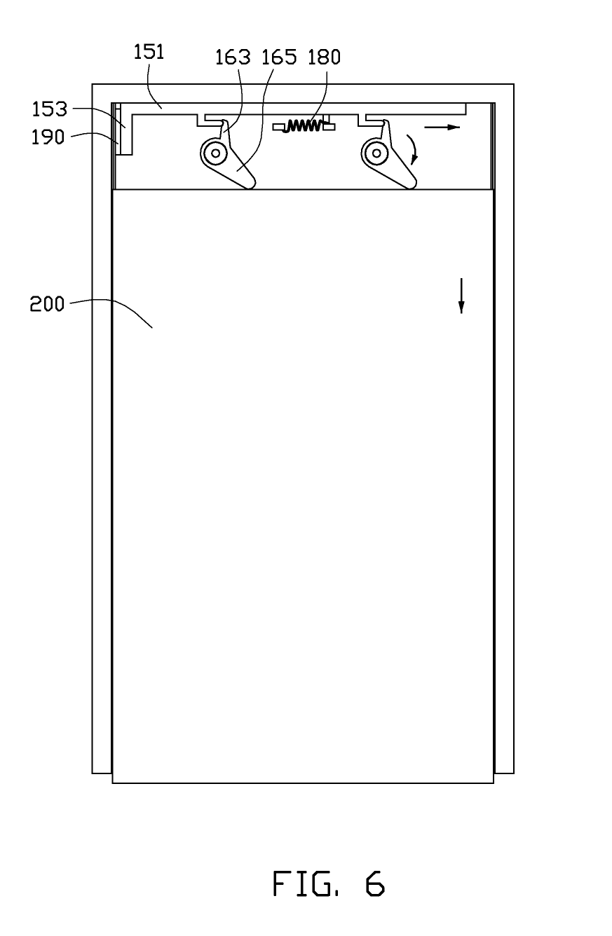

FIGS. 5 and 6 illustrate two states of the data storage device 200 relative to the extension tray 100. In use, the data storage device 200 extends into the extension tray 100, the plurality of second teeth 2232 on lateral sides of the data storage device 200 engages with the buffer member 124, and the two guiding rails 122 on the sidewalls 120 engage with the corresponding guiding slots 221. The data storage device 200 is moved into the extension tray 100. To remove the data storage device 200 from the extension tray 100, the button 190 is pressed. The rod 150 moves along a first direction substantially perpendicular to the sidewall 120. The two engaging posts 1552 urge the two pushing rotators 160 to rotate. The two pushing portions 165 push out the data storage device 200 along a second direction which is substantially perpendicular to the first direction. The data storage device 200 can then be removed from the extension tray 100. When the button 190 is released, the resilient element 180 drives the rod 150 back to an original position.

It is also understood, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An extension tray for a data storage device, comprising:
a bottom wall;
two sidewalls substantially perpendicular to the bottom wall, the two sidewalls substantially parallel to each other, a buffer member protruding form one of the two sidewalls, and the buffer member is configured to buffer a movement of the data storage device when the data storage device moves between the two sidewalls; and
a detaching assembly being accessible through one of the two sidewalls;
wherein the detaching assembly is configured to move along a first direction to urge the data storage device to move along a second direction, and the first direction is substantially perpendicular to the second direction.

2. The extension tray of claim 1, wherein a guiding rail is located on each of the two sidewalls to guide the data storage device, an extension direction of each guiding rail is substantially parallel to the bottom wall, and a cross section of each guiding rail is substantially rectangular.

3. The extension tray of claim 1, wherein the buffer member comprises a wheel rotatably mounted to the one of the two sidewalls.

4. The extension tray of claim 3, wherein the wheel comprises a plurality of teeth to engage with the data storage device.

5. The extension tray of claim 1, wherein the detaching assembly comprises a rod, a resilient member, and at least one pushing rotators; the rod is configured to move along the first direction to rotate the at least one pushing rotators; and the at least one pushing rotators is pivotable relative to the bottom wall, and is configured to push out the data storage device.

6. The extension tray of claim 5, wherein a through hole is defined in one of the two sidewalls, the detaching assembly further comprises a button movably received in the through hole, and the button abuts the rod.

7. The extension tray of claim 5, wherein the at least one pushing rotators comprises a driving portion and a pushing portion, the driving portion is engaged with the rod, and the pushing portion is configured to push the data storage device.

8. The extension tray of claim 7, wherein an angle defined between the driving portion and the pushing portion is substantially greater than 90 degrees.

9. The extension tray of claim 8, wherein the rod comprises an engaging post, and a recess is defined in the driving portion to receive the engaging post.

10. An extension tray for a data storage device, comprising:
a bottom wall;
two sidewalls substantially perpendicular to the bottom wall, the two sidewalls substantially parallel to each other; and
a detaching assembly comprising a rod, a resilient member, and at least one pushing rotator; the resilient member is secured between the rod and the bottom wall, the rod being configured to move along a first direction to rotate the at least one pushing rotator, the at lest one rotator configured to be driven to rotate and urge the data storage device to move along a second direction, and the first direction substantially perpendicular to the second direction.

11. The extension tray of claim 10, wherein a guiding rail is located on each of the two sidewalls to guide the data storage device; an extension direction of each guiding rail is substantially parallel to the bottom wall, and a cross section of each guiding rail is substantially rectangular.

12. The extension tray of claim 10, wherein a buffer member protrudes form one of the two sidewalls, and the buffer member is configured to buffer a movement of the data storage device when the data storage device moves between the two sidewalls.

13. The extension tray of claim 12, wherein the buffer member comprises a wheel rotatably mounted to the one of the two sidewalls.

14. The extension tray of claim 13, wherein the wheel comprises a plurality of teeth to engage with the data storage device.

15. The extension tray of claim 10, wherein the at least one pushing rotator is pivotable relative to the bottom wall.

16. The extension tray of claim 10, wherein a through hole is defined in one of the two sidewalls, and the detaching assembly further comprises a button movably received in the through hole, and the button abuts the rod.

17. The extension tray of claim 10, wherein the at least one pushing rotator comprises a driving portion and a pushing portion; the driving portion is engaged with the rod, and the pushing portion is configured to push the data storage device.

18. The extension tray of claim 17, wherein an angle defined between the driving portion and the pushing portion is substantially greater than 90 degrees.

19. The extension tray of claim 18, wherein the rod comprises an engaging post, and a recess is defined in the driving portion to receive the engaging post.
